(19) United States
(12) Patent Application Publication
(10) Pub. No.: US 2025/0173138 A1
(43) Pub. Date: May 29, 2025

(54) MICRO-CONTROLLER-UNIT, METHOD AND COMPUTER PROGRAM FOR DOWNGRADE PREVENTION

(71) Applicant: HYUNDAI AUTOEVER CORP., Seoul (KR)

(72) Inventor: Jae Hyun Lim, Seoul (KR)

(73) Assignee: HYUNDAI AUTOEVER CORP., Seoul (KR)

(21) Appl. No.: 18/955,024

(22) Filed: Nov. 21, 2024

(30) Foreign Application Priority Data
Nov. 23, 2023 (KR) 10-2023-0163928

(51) Int. Cl. G06F 8/65; G06F 8/61

(52) U.S. Cl. CPC G06F 8/65; G06F 8/63

(57) ABSTRACT

A method for preventing a downgrade in a Micro-controller Unit (MCU) includes writing a reprogram image in a first flash memory through a bootloader. The method also includes recording function pointers in a predetermined location in an application loaded according to the reprogram image and calling a function designated by one of the function pointers through the bootloader to check a previous version value stored in a second flash memory. The method additionally includes deleting the reprogram image written in the first flash memory, when a current version value included in the application is identified to be a downloaded value compared to the previous version value.

### CROSS REFERENCE TO RELATED APPLICATION

This application claims the benefit of and priority to Korea Patent Application No. 10-2023-0163928, filed on Nov. 23, 2023, the entire contents of which are hereby incorporated herein by reference.

### FIELD OF TECHNOLOGY

The present disclosure relates to reprogramming of a Micro-controller Unit (MCU). More particularly, the present disclosure relates to an MCU, a method, and a computer program that prevent a version from being downgraded when reprogramming the MCU.

### BACKGROUND

A Micro-controller Unit (MCU) includes a Central Processing Unit (CPU) that performs main operations and command interpretation, as the brain of the MCU. The MCU includes a memory, which may be classified into Random Access Memory (RAM) and Read-Only Memory (ROM) or flash memory. The RAM temporarily stores data, and may be a kind of workspace that the CPU uses when executing an application. Further, the ROM or the flash memory may be a memory that stores the program code of the MCU for a long period of time. The MCU includes Input/Output (I/O) Ports, through which it may communicate with an external device and download a new program image. The MCU may include a timer and a counter, which may be used to maintain regular time intervals or count the number of times a particular event occurs. The MCU may further include a clock circuit and a power management circuit.

When power is supplied to the MCU, an initialization process begins. During this process, the hardware and memory components of the MCU are initialized, and clock settings and interrupt handling functions are prepared. After power is supplied, a bootloader of the MCU is executed, which loads the application into the memory or upgrades the program for the application. When the bootloader is executed, the application is loaded into the RAM according to the program stored in the flash memory. The application's commands and data are stored in a specific address area of RAM. When the application is loaded into the RAM, the CPU tracks the addresses, fetches instructions from the RAM, and executes them sequentially. While the application is running, the CPU uses the RAM to manage variables, stacks, heaps, etc. When the application execution is completed, the CPU clears the RAM and returns the state of the MCU to its initial state.

The application running on the MCU may be updated with a new program. This process is sometimes called reprogramming. A Flash Bootloader (FBL) and an Over-The-Air (OTA) are known as update technologies applied to the automotive MCU. The FBL is a software module that supports the update of the MCU application. It is usually stored in the ROM or flash memory of the MCU and is automatically executed when the MCU starts. The primary role of the FBL is to safely download a new program image and program the image in the flash memory. It also performs validation of the program image and handles a communication error. By using the FBL, it is possible to directly connect to a device and update the application. This is useful when the device is operating in a field, and allows the MCU's function to be improved or bugs to be fixed without visiting a service center. The OTA is a technology that remotely updates the application of the MCU through a wireless network. Typically, the OTA may work with the FBL to handle application updates. While the FBL updates the application on the device, the OTA downloads a new program image from a remote server and transmits it to the device. The OTA updates may be performed automatically without user intervention, making it easy to update all devices simultaneously.

The RAM and flash memory used in the MCU have different operating principles, and may have different units for erasing and writing data. In the RAM, the unit for erasing data is usually a bit or a byte. Accordingly, data may be read and written in individual bits or bytes. To erase data from the RAM, voltage is simply removed from the memory cell. The RAM retains data only while power is supplied, and loses all pieces of data when power is cut off. In the flash memory, the unit for erasing data is usually a block or sector. One block may be composed of thousands to tens of thousands of memory cells, and data may be erased only in blocks. To erase data from the flash memory, the voltage of the corresponding block should be increased to initialize the memory cells. This is referred to as flash erasing. The flash memory may retain data even when power is cut off, and is also called a non-volatile memory.

When the MCU is reprogrammed, a version may be upgraded or downgraded. Regarding the reprogramming, various groups or companies are creating regulations to prevent downgrades. These institutions are creating regulations to prevent downgrades because allowing downgrades may cause a number of problems. First, if the downgrades are allowed, vulnerabilities that have already been fixed through security updates may be exploited again. If the version is downgraded to a previous version of software or firmware, the security vulnerabilities may re-emerge. In particular, since automobiles are a field directly related to safety, downgrading the firmware or software may cause serious problems. A latest version of software usually contains fixes for flaws found in earlier versions. Downgrading to a previous version may cause these flaws to re-occur, which may cause safety issues in an automobile. Further, the automotive industry is subject to regulations in many countries and regions. In particular, the latest software or firmware often includes functions required to meet regulatory requirements. Downgrading to a previous version may not meet regulatory requirements. Further, downgrading to a previous version of software or firmware may result in inconsistencies with current services provided by a vehicle manufacturer or service provider.

For these various reasons, downgrade prevention regulations for the automotive MCU are emerging. The MCU specifications required to satisfy the downgrade prevention regulations are high, making it difficult to apply the downgrade prevention regulations to low specification MCUs. In particular, due to limitations in the characteristics of the afore-mentioned RAM and flash memory and the operating method of the MCU, the downgrade prevention regulations are not properly applied to low specification MCUs.

The discussions in this Background section are intended merely to provide background information and do not constitute an admission of prior art.

### SUMMARY

Embodiments of the present disclosure provide a technique for preventing a version from being downgraded when reprogramming an MCU. Technical objects achieved by the present disclosure are not limited to those described above. Other technical objects that are not mentioned herein should be more clearly understood from the descriptions below by those having ordinary skill in the art to which the present disclosure pertains.

According to an embodiment of the present disclosure, a method for preventing downgrading of an application in a Micro-controller Unit (MCU) is provided. The method comprising the steps of writing a reprogram image in a first flash memory through a bootloader; identifying a previous version value of the application stored in a second flash memory by calling, through the bootloader, a function designated by one of function pointers, which are recorded in a predetermined location (e.g., a location agreed upon with the bootloader) in the application to be loaded by the reprogram image; and deleting the reprogram image written in the first flash memory, when a current version value included in the application is identified to be a downloaded value compared to the previous version value.

The function pointers may be recorded in a first predetermined location in a Volume Boot Record (VBR) area of the application.

The method may include the step of, before writing the reprogram image in the first flash memory, scanning a partition flag variable in a second predetermined location in the VBR area, and when the partition flag variable may not be checked in the second location in the step of scanning the partition flag variable, the step of writing the reprogram image in the first flash memory may not be executed.

The method may further include the step of verifying integrity of the reprogram image, and, when the integrity of the reprogram image is not verified in the step of verifying the integrity of the reprogram image, the reprogram image written in the first flash memory may be deleted.

The method may further include the step of changing a value of the partition flag variable in the second predetermined location of the VBR area, when the current version value included in the application is identified to be an upgraded value compared to the previous version value.

The method may further include the step of checking a format of a pre-agreed or predetermined area in the VBR area, before the step of checking the previous version value stored in the second flash memory, and, when the format of the pre-agreed or predetermined area is different from a pre-agreed or predetermined format in the step of checking the format of the pre-agreed or predetermined area, the step of checking the previous version value stored in the second flash memory may not be executed.

Functions designated by the function pointers may be functions that enable access to the second flash memory by an emulator.

The method may further include the step of recording the previous version value recorded in a first block of the second flash memory in a second block of the second flash memory, and recording the current version value in the first block of the second flash memory, when the current version value included in the application is identified to be an upgraded value compared to the previous version value.

According to another embodiment of the present disclosure, a Micro-controller Unit (MCU) is provided. The MCU includes a first flash memory configured to store a program image, a second flash memory configured to store data, and a Random Access Memory (RAM) configured to load the program image. The MCU also includes a Central Processing Unit (CPU) configured to write a reprogram image in the first flash memory and check function pointers in a predetermined (e.g., pre-agreed upon) location of an application loaded in the RAM according to the reprogram image. The CPU is also configured to call a function designated by one of the function pointers to identify a previous version value stored in the second flash memory. The CPU is further configured to delete the reprogram image written in the first flash memory, when a current version value included in the application is identified to be a downgraded value compared to the previous version value.

The MCU may further include an emulator configured to manage to storing and deleting data for the second flash memory Functions designated by the function pointers may be functions that enable access to the second flash memory through the emulator.

The emulator among a bootloader and the application may be accessed by functions located in the application.

A variable storing an index of a block storing the previous version value in the second flash memory and a variable indicating a status value of the block may be formed in pre-agreed or predetermined locations in a Volume Boot Record (VBR) area of the application.

The CPU may call functions designated to by the function pointers according to the status value of the block, and check the previous version value stored in the second flash memory.

The RAM may erase data in bit or byte units, and the second flash memory may erase data in block units.

The function pointers may be recorded in a first predetermined location in the VBR area of the application, and the CPU may read an address value of one function pointer in the first location and then jump to an execution location with a corresponding address value to call the function.

The CPU may verify integrity of the application, and delete a reprogram image stored in the first flash memory, if the integrity is not verified.

The CPU may load the bootloader into the RAM to execute it, and perform an operation of writing and deleting the reprogram image in and from the first flash memory according to the bootloader.

Functions designated by the function pointers may include a function handling a Non-volatile Memory (NvM) module, a function handling a Flash EEPROM Emulation (Fee) module, and a function handling a Flash Driver (Fls) module.

When the current version value include in the application is identified to be an upgraded value compared to the previous version value, the CPU may record the previous version value recoded in a first block of the second flash memory in a second block of the second flash memory, and record the current version value in the first block of the second flash memory.

According to yet another embodiment of the present disclosure, a non-transitory medium storing computer-readable instructions that, when executed by a processor, case the processor to: write a reprogram image in a first flash memory; identify a previous version value of the application stored in a second flash memory by calling, through the bootloader, a function designated by one of function pointers, which are recorded in a predetermined location (e.g., a location agreed upon with a bootloader) in the application to be loaded by the reprogram image; and delete the reprogram image written in the first flash memory, when a current version value included in the application is identified to be a downloaded value compared to the previous version value.

Embodiments of the present disclosure have the effect of preventing a version from being downgraded when reprogramming an MCU.

### BRIEF DESCRIPTION OF THE DRAWINGS

In order that the disclosure may be well understood, there are now described various forms thereof, given by way of example, reference being made to the accompanying drawings, in which:

FIG. 1 is a configuration diagram of an MCU according to an embodiment.

FIG. 2 is a diagram illustrating the process of reprogramming the MCU according to an embodiment.

FIG. 3 is a configuration diagram of a reprogram image according to an embodiment.

FIG. 4 is a diagram illustrating the format of a portion of a header area of a reprogram image according to an embodiment.

FIG. 5 is a flowchart of a version check method according to an embodiment.

### DETAILED DESCRIPTION

Hereinafter, embodiments of the present disclosure are described in detail with reference to the accompanying drawings. With regard to the reference numerals of the components of the respective drawings, it should be noted that the same reference numerals are assigned to the same components even when the components are shown in different drawings. In addition, in describing the present disclosure, detailed descriptions of well-known configurations or functions have been omitted in order to not obscure the gist of the present disclosure.

In addition, terms such as “1st”, “2nd”, “A”, “B”, “(a)”, “(b)”, or the like may be used in describing the components of the present disclosure. These terms are intended only for distinguishing a corresponding component from other components, and the nature, order, or sequence of the corresponding component is not limited to the terms. In the case where a component is described as being “coupled”, “combined”, or “connected” to another component, it should be understood that the corresponding component may be directly coupled or connected to another component or that the corresponding component may also be “coupled”, “combined”, or “connected” to the component via another component provided therebetween.

When a component, device, module, element, or the like of the present disclosure is described as having a purpose or performing an operation, function, or the like, the component, device, or element should be considered herein as being “configured to” meet that purpose or perform that operation or function.

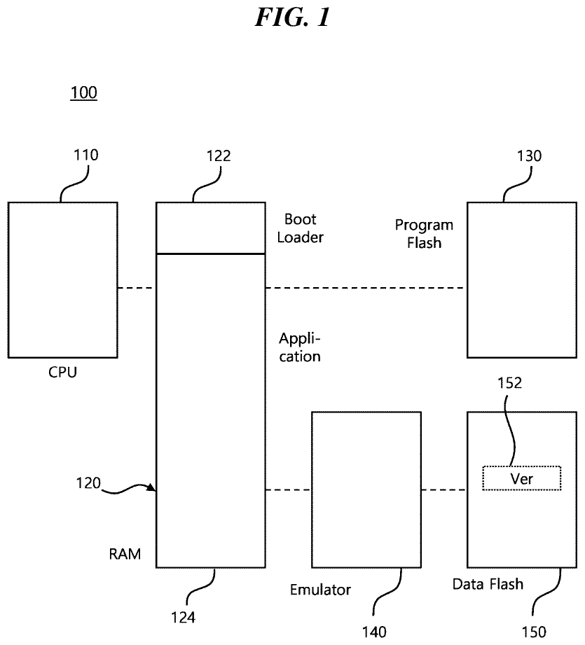

FIG. 1 is a configuration diagram of a Micro-controller Unit (MCU) according to an embodiment.

Referring to FIG. 1, an MCU 100 may include a processor (e.g., a CPU) 110, a RAM 120, a first flash memory 130, an emulator 140, and a second flash memory 150.

The MCU 100 may be used to control various devices. For example, the MCU 100 may control an engine, an electronic unit, a safety system, an infotainment system, etc. The MCU 100 may be connected to various sensors and may collect data from the sensors. The sensors may provide data such as a vehicle speed, the temperature, humidity, and air pressure of the surrounding environment. The MCU 100 may use a communication protocol such as Controller Area Network (CAN), Local Interconnect Network (LIN), or FlexRay to communicate with other devices inside the vehicle. The MCU 100 may require high reliability and safety. In various embodiments, the MCU 100 may have functions such as (Error-Correcting Code (ECC) memory, watchdog timer, and/or fail-safe.

The MCU 100 may include flash memory to update an application. This is also called firmware update or software update. Hereinafter, for convenience of explanation, what is written in the flash memory in relation to a program is referred to as a program image, and what is loaded into RAM according to the program image is referred to as the application. When the program is updated, it is called a reprogram. In this process, when a version goes up, it is called an upgrade, and when the version goes down, it is called a downgrade. However, these terms are for convenience of explanation, and the embodiments of the present disclosure are not limited to these terms.

The CPU 110 performs arithmetic and logic operations to process input data and output results. Thereby, tasks such as sensor data processing and control command calculation are performed. The CPU 110 may control the operation of the MCU 100 by sequentially executing commands of the application. Thus, the MCU 100 may be connected to various devices, process sensor data, or perform communication. The CPU 110 may have a small memory unit called a register. The register may be used for temporarily storing data or storing the results of operation during data operation or instruction execution. A control unit within the CPU 110 may control communication with other components within the MCU 100, thereby controlling a command execution order.

The RAM 120 may include a boot area 122 and an application area 124. A boot loader may be loaded into the boot area 122. Loading of the bootloader may be understood as loading a code for the bootloader. Further, the application may be loaded into the application area 124. The loading of the application may be understood as loading the code for the application. The bootloader may be a first program executed when the MCU 100 starts (when power is turned on or a reset occurs). The bootloader may be stored in the flash memory, and may be loaded into the boot area 122 of the RAM and executed when the MCU 100 starts. The bootloader may initialize hardware of the MCU 100 and may perform necessary settings. The bootloader may reprogram the application. For example, the bootloader may receive a reprogram image from outside and may store it in the flash memory. The bootloader may then load and execute a new application when a next MCU 100 starts. Once the initialization task by the bootloader is completed, an application code may be loaded from the flash memory into the RAM. Further, the loaded application code may be executed in the application area 124 of the RAM and may perform a main function of the MCU 100.

The MCU 100 may include a first flash memory 130 and a second flash memory 150. The first flash memory 130 may be called a program flash memory, while the second flash memory 150 may be called a data flash memory. The first flash memory 130 may primarily store the program, and the bootloader and the application may be stored in the first flash memory 130. The second flash memory 150 may be used as a space for storing non-volatile data, and may have the characteristic of maintaining data even when the power of the MCU 100 is turned off or reset occurs. Thus, important information such as setting values, log data, and calibration data may be stored in the second flash memory 150.

The first flash memory 130 and the second flash memory 150 may be divided into areas within one device. For example, in a single flash memory, areas may be divided by an address range, with an area allocated for the first flash memory 130 and an area allocated for the second flash memory 150.

The flash memory is a cost-effective way to store and maintain data, but has limitations in that it may generally be erased or written only in block units. To overcome the limitations, a Fee (Flash EEPROM Emulation) function may be used to emulate the function of reading and writing data in byte units, like EEPROM, in the flash memory. In addition, the emulator 140 performs the function in the MCU 100.

The emulator 140 may provide a function similar to the electrically erasable programmable read-only memory (EEPROM) using the second flash memory 150 allocated for the Fee function. Thereby, data may be read and written in byte units, and it may not be necessary to perform erasing or writing in block units. Since the flash memory has a limited number of write/erase cycles, repeatedly writing in the same location may damage that area. The emulator 140 may manage write and erase operations to be evenly distributed using wear leveling, thereby increasing the lifespan of the flash memory. The emulator 140 may also provide a garbage collection function that automatically erases unnecessary data. When data is updated or deleted, previous data becomes unnecessary. The emulator 140 may efficiently manage a flash memory space by cleaning up such unnecessary data.

The bootloader's direct access to the second flash memory 150—data flash memory—may be restricted for various reasons. The bootloader is responsible for initializing the MCU, updating the program, and loading the application code. The second flash memory 150—data flash memory—is generally an area used by the application code and may be separated from the bootloader according to a layer separation principle. Further, the data stored in the second flash memory 150—data flash memory—may be managed by the emulator 140. If the bootloader directly accesses this area, it may disrupt a data management method, making it difficult to ensure the integrity and consistency of the data. In order for the bootloader to directly access the second flash memory 150—data flash memory—it should manage complex logic such as the address map of the flash memory, wear leveling, and garbage collection. Since this is problematic in that the complexity of the software is increased and maintenance is difficult, the direct access of the bootloader to the second flash memory 150—data flash memory—may be restricted.

In the configuration of the MCU 100 and the constraint conditions of each configuration, performing reprogramming while preventing downgrade of the MCU 100, according to an embodiment, is described below.

The MCU 100 may compare a current version value recorded in the reprogrammed application with a previous version value stored in the MCU 100, and may stop the reprogramming when the current version value is lower than the previous version value. Here, stopping may be understood to include at least one action, such as preventing the execution of the application due to reprogramming or deleting the reprogram image written in the flash memory.

At this time, there may be an issue as to where to store the previous version value. The previous version value is a value verified by the bootloader, and may be stored in the RAM 120 for ease of access. However, this may be problematic in that the stored previous version value is lost in an emergency situation such as a power failure. Alternatively, it may be stored in the first flash memory 130—program flash memory—that the bootloader may access. In this case, since the first flash memory 130—program flash memory—is not managed by the emulator 140, there may be a problem where more memory space than necessary should be allocated to store the previous version value.

Thus, the MCU 100 may store the previous version value in a location 152 of the second flash memory 150. Since the second flash memory 150 is managed by the emulator 140, only a small memory space may be allocated, and the lifespan problem during writing and erasing may also be solved. However, as described above, it may have a problem that the bootloader does not directly access the second flash memory 150.

Embodiments according to the present disclosure solve the above-described problem by causing function pointers to be recorded in a pre-agreed or predetermined location in a header of the application loaded according to the reprogram image and allowing the bootloader to access the second flash memory 150 through functions designated by the function pointers. Hereinafter, these embodiments are described.

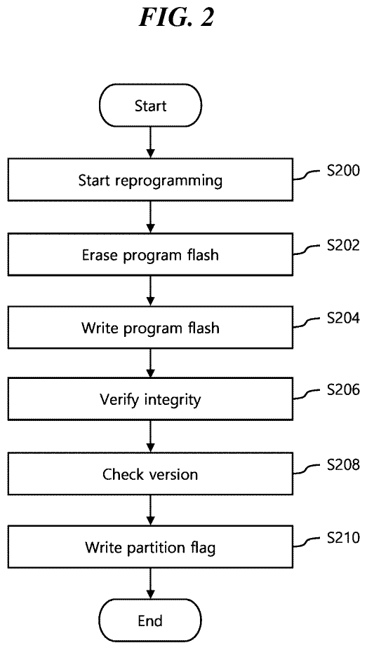

FIG. 2 is a diagram illustrating the process of reprogramming the MCU according to an embodiment.

Referring to FIG. 2, the MCU may start reprogramming in an operation S200. Hereinafter, the operation of the MCU may be understood as being performed by the CPU.

When the MCU starts reprogramming, a VBR (Volume Boot Record) area may be scanned in the application area of RAM. A portion of the VBR area may have a pre-agreed or predetermined format. For example, pre-agreed or predetermined function pointers may be located at a pre-agreed or predetermined first location (address), and pre-agreed or predetermined variables may be located at a pre-agreed or predetermined second location. When the MCU starts reprogramming, it may may the VBR area and check if the VBR area has a pre-agreed or predetermined format. Further, the MCU may not perform a subsequent reprogramming step if the VBR area does not have a pre-agreed or predetermined format.

For example, according to an embodiment, a valued may be stored in a partition flag variable to indicate whether the reprogram is normally performed. The partition flag variable may be located at a pre-agreed or predetermined location in the VBR area and may have a certain range of values. When the MCU starts reprogramming, it may scan the partition flag variable at a pre-agreed or predetermined location in the VBR area. Further, if the MCU may not check the partition flag variable at that location, the MCU may not perform subsequent reprogramming steps, such as the step of erasing the first flash memory in an operation S202 and the step of writing the reprogram image in the first flash memory in an operation S204.

The MCU may erase the data currently stored in the first flash memory in the operation S202.

After erasing the first flash memory, the MCU may write the reprogram image in the first flash memory through the bootloader in the operation S204. The bootloader may confirm the need for reprogramming by connecting to an external device through a communication interface or by examining a stored flag or metadata. Then, if the need for reprogramming is confirmed, the bootloader may receive the reprogram image from the external device. The bootloader may record the received reprogram image in the first flash memory. The record may be made in block units.

After writing the reprogram image in the first flash memory, the MCU may verify the integrity and accuracy of the recorded data in an operation S206. To this end, the MCU may use techniques such as CRC (Cyclical Redundancy Check) and hash functions. If the integrity verification fails, the MCU may delete the reprogram image recorded in the first flash memory and may not perform subsequent steps.

After the integrity has been verified, the MCU may check the version by comparing the current version value recorded in the downloaded application with the previous version value recorded in the previous application in an operation S208.

When it is confirmed that the current version value included in the application is a downgraded value compared to the previous version value, the MCU may delete the reprogram image written in the first flash memory and may not perform subsequent steps.

Further, when it is confirmed that the current version value included in the application is an upgraded value or the same value as the previous version value, the MCU may change the value of the partition flag variable in a predetermined location in the VBR area to indicate that the reprogramming has been normally performed in an operation S210.

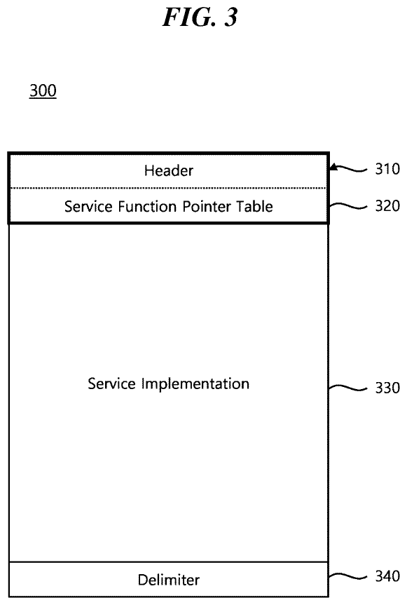

FIG. 3 is a configuration diagram of a reprogram image according to an embodiment.

Referring to FIG. 3, the reprogram image 300 may include a header 310, a body 330, and a delimiter 340.

The reprogram image 300 is a binary form of software to be executed on the MCU. The reprogram image 300 includes executable files, program code, libraries, etc., and may be generated through a compilation and linking process. The reprogram image 300 is in binary form, which may be in the form of machine language that the MCU may directly interpret and execute. The reprogram image 300 may include a memory map. The memory map may define a memory area of the program, such as code, data, stack, and heap, and may allocate a memory based on this area when the program is executed.

Codes for implementing services provided by the MCU may be placed in the body 330, and patterns for clearly indicating an end of the reprogram image 300 may be placed in the delimiter 340. The bootloader may check the delimiter 340 to confirm that the reprogram image 300 has been received.

The header 310 may include version information about the current version value, and may include a signature used to verify that the image is valid and in the expected format. In addition, it may include a CRC value, an entry point indicating a memory address where the program code begins, metadata, etc.

In the header 310 of the reprogram image 300 according to an embodiment, the function pointers 320 may be recorded in a pre-agreed or predetermined location.

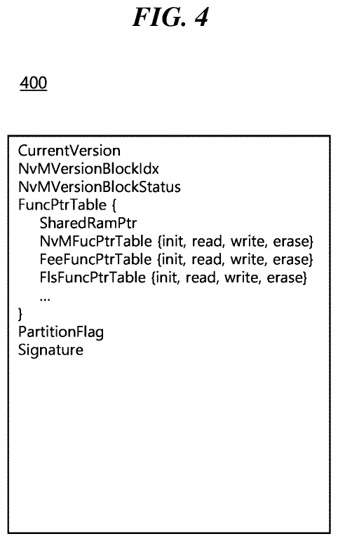

FIG. 4 is a diagram illustrating the format of a portion of a header area of a reprogram image according to an embodiment.

Referring to FIG. 4, a pre-agreed or predetermined format may be formed at the pre-agreed or predetermined location of the header.

A variable (CurrentVersion) for the current version value, a variable (NvMVersionBlockIdx) for the index of the block storing the previous version value in the second flash memory, a variable (NvMVersionBlockStatus) indicating the status of the block storing the previous version value in the second flash memory, function pointers (FuncPtrTable), a version value variable pointer (SharedRamPtr), a partition flag variable (PartitionFlag), a signature variable (Signature), etc. may be formed in a pre-agreed or predetermined location (address).

Since the variables and the function pointers are formed at pre-agreed or predetermined locations (addresses), the bootloader may access the variables and the function pointers and then read their values.

The functions designated by the function pointers (FuncPtrTable) are functions that enable access to the second flash memory by the emulator. The CPU included in the MCU may read address values from the function pointers and then jump to the execution location with the corresponding address value to call the afore-mentioned functions.

In order to access the second flash memory through the emulator, the NvM (Non-volatile Memory) function, Fee (Flash EEPROM Emulation) function, and Fls (Flash Driver) function, which form three layers, may need to be used. The NvM function may be responsible for managing data in the second flash memory. This function performs tasks such as storing, reading, and deleting data for the second flash memory, and the Fee function may be used for this purpose.

The Fee function may provide the function of emulating the use of the secondary flash memory as the Electrically Erasable Programmable Read-Only Memory (EEPROM). The Fee function performs functions such as wear leveling, recovery, and background error investigation of data blocks, and the Fls function may be used for this purpose.

The Fls function may be a driver that directly accesses the hardware of the second flash memory. This function may perform operations such as reading, writing, and erasing sectors of the second flash memory.

NvMFuncPtrTable function pointers may be function pointers pointing to NvM functions, FeeFuncPtrTable function pointers may be function pointers pointing to Fee functions, and FlsFuncPtrTable function pointers may be function pointers pointing to Fls functions. Each function may separately have an init function, a read function, a write function, or an erase function.

The bootloader may first call the NvM init function, the Fee init function, and the Fls init function using each function pointer.

Further, the bootloader may read the previous version value stored in the second flash memory by calling the NvM read function designated by one of the function pointers. At this time, the bootloader may use NvMVersionBlockIdx and SharedRamPtr as arguments to the NvM read function.

Further, the bootloader may write the previous version value in the second flash memory by calling the NvM write function designated by another function pointer among the function pointers. At this time, the bootloader may use NvMVersionBlockIdx and SharedRamPtr as arguments to the NvM write function.

Further, the bootloader may erase the previous version value from the secondary flash memory by calling the NvM erase function designated by another function pointer among the function pointers. At this time, the bootloader may use NvMVersionBlockIdx.

The bootloader may check the status using a variable (NvMVersionBlockStatus) indicating the status of the block storing the previous version value in the secondary flash memory, and perform subsequent operations when the status is determined to be normal.

Hereinafter, a version check process for preventing the downgrade using the function pointers, according to an embodiment, is described.

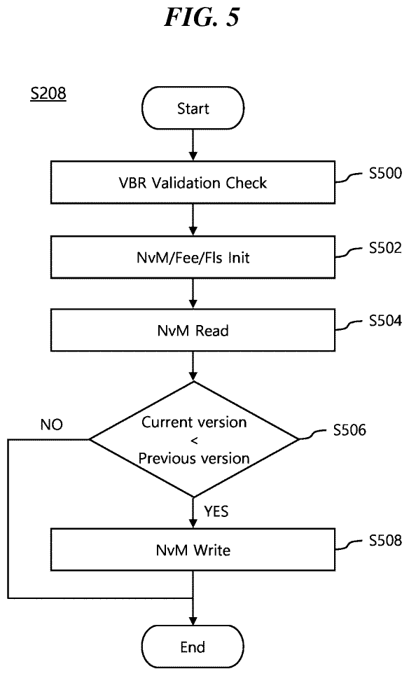

FIG. 5 is a flowchart of a version check method according to an embodiment.

Referring to FIG. 5, in an operation S500, the MCU may check the format of a pre-agreed or predetermined area in the VBR area of the application corresponding to the header area of the reprogram image. If the format of the pre-agreed or predetermined area is different from the pre-agreed or predetermined format, the MCU may not execute subsequent steps, such as the step or operation S504 of checking the previous version value stored in the second flash memory.

After checking the format of the pre-agreed or predetermined area in the VBR, the MCU may read the function pointers from that area and check the index of the block where the previous version value is stored in the second flash memory. The functions designated by the function pointers may be functions that enable access to the second flash memory by the emulator.

The MCU may perform an initialization operation for accessing the second flash memory by calling some of the functions designated by the corresponding function pointers in an operation S502. For example, the MCU may call the NvM init function, Fee init function, and Fls init function using some of the function pointers.

When initialization is successfully completed, the MCU may call the function designated by one of the function pointers to check the previous version value stored in the second flash memory in an operation S504.

In an operation, the MCU compares the current version value included in the application with the previous version value stored in the second flash memory. If it is upgraded or the same version (YES in the operation S506), the current version value may be stored in the second flash memory in an operation S508. To prepare for an unexpected termination, the MCU may first record the previous version value recorded in the first block of the second flash memory in the second block of the second flash memory, and then record the current version value in the first block of the second flash memory.

If the downgrade is confirmed by comparing the current version value with the previous version value (NO in the operation S506), the MCU may terminate the version check step or operation S208 and may delete the reprogram image stored in the first flash memory.

If the FBL directly includes functions such as NvM, Fee, and Fls, the code size of the FBL may increase, and a problem may arise where a large area of the flash memory should be allocated to the FBL to store a small number of variables. To solve this problem, this embodiment presents as an example a structure in which function pointers of an agreed upon or predetermined format are located at specific locations in the application image, and the FBL calls the afore-mentioned functions through these function pointers. This example structure allows NvM persistent data to be stored while calling application functions from the FBL's stack space. This embodiment can amplify the effects of the above-described process, as it performs an integrity check after downloading the application image.

As described above, this embodiment has the effect of preventing a version from being downgraded when reprogramming an MCU.

It should be understood that the terms “comprise”, “include”, “have”, etc. when used in this specification, specify the presence of stated components but do not preclude the presence or addition of one or more other components, unless the context clearly indicates otherwise. Unless otherwise defined, all terms including technical and scientific terms used herein have the same meaning as commonly understood by one of ordinary skill in the art to which the present disclosure pertains. It should be further understood that terms used herein should be interpreted as having a meaning that is consistent with their meaning in the context of this specification and the relevant art and should not be interpreted in an idealized or overly formal sense unless expressly so defined herein.

The above description is merely an example of the technical idea of the present disclosure, and those having ordinary skill in the art should appreciate that various modifications and changes may be made without departing from the essential characteristics of the present disclosure. Thus, the embodiments disclosed in the present disclosure are not intended to limit the technical idea of the present disclosure but to explain it, and the scope of the technical idea of the present disclosure is not limited by the embodiment. The protection scope of the present disclosure should be interpreted by the claims below, and all technical ideas within a scope equivalent thereto should be interpreted as being included in the scope of the rights of the present disclosure.

What is claimed is:

1. A method for preventing downgrading of an application in a Micro-controller Unit (MCU), the method comprising:
writing a reprogram image in a first flash memory through a bootloader;
identifying a previous version value of the application stored in a second flash memory by calling, through the bootloader, a function designated by one of function pointers that are recorded in a predetermined location in the application to be loaded by the reprogram image; and
deleting the reprogram image written in the first flash memory, when a current version value included in the application is identified to be a downloaded value compared to the previous version value.

2. The method of claim 1, wherein the function pointers are recorded in a first predetermined location in a Volume Boot Record (VBR) area of the application.

3. The method of claim 2, further comprising before writing the reprogram image in the first flash memory, scanning for a partition flag variable in a second location predetermined in the VBR area, wherein, when the partition flag variable is not identified at the second location, the writing of the reprogram image in the first flash memory is not performed.

4. The method of claim 1, further comprising verifying integrity of the reprogram image, wherein, when the integrity of the reprogram image is not verified, the reprogram image written in the first flash memory is deleted.

5. The method of claim 3, further comprising changing a value of the partition flag variable in the second location predetermined in the VBR area, when the current version value included in the application is identified to be an upgraded value compared to the previous version value.

6. The method of claim 2, further comprising identifying a format of a predetermined area in the VBR area before identifying the previous version value stored in the second flash memory, wherein, when the format of the predetermined area is different from a predetermined format, the identifying of the previous version value stored in the second flash memory is not performed.

7. The method of claim 1, wherein functions designated by the function pointers are functions that enable access to the second flash memory by an emulator.

8. The method of claim 1, further comprising:
when the current version value included in the application is identified to be an upgraded value compared to the previous version value,
recording the previous version value, recorded in a first block of the second flash memory, in a second block of the second flash memory, and
recording the current version value in the first block of the second flash memory.

9. A Micro-controller Unit (MCU), the MCU comprising:
a first flash memory configured to store a program image;
a second flash memory configured to store data;
a Random Access Memory (RAM) in which the program image is loaded; and
a Central Processing Unit (CPU) configured to
write a reprogram image in the first flash memory,
check function pointers in a predetermined location of an application to be loaded in the RAM according to the reprogram image,
call a function designated by one of the function pointers to identify a previous version value stored in the second flash memory, and
delete the reprogram image written in the first flash memory, when a current version value included in the application is identified to be a downgraded value compared to the previous version value.

10. The MCU of claim 9, further comprising an emulator configured to manage storage and deletion of data for the second flash memory, wherein functions designated by the function pointers are functions that enable access to the second flash memory through the emulator.

11. The MCU of claim 10, wherein the emulator is accessed by functions located in the application, among a bootloader and the application.

12. The MCU of claim 9, wherein a variable storing an index of a block storing the previous version value in the second flash memory and a variable indicating a status value of the block are formed in predetermined locations in a Volume Boot Record (VBR) area of the application.

13. The MCU of claim 12, wherein the CPU is configured to call functions designated by the function pointers according to the status value of the block and identifies the previous version value stored in the second flash memory.

14. The MCU of claim 9, wherein:
the RAM is configured to erase data in bit or byte units; and
the second flash memory is configured to erase data in block units.

15. The MCU of claim 9, wherein:
the function pointers are recorded in a first location predetermined in the VBR area of the application; and
the CPU is configured to
read an address value of one function pointer in the first location, and
jump to an execution location with a corresponding address value to call the function.

16. The MCU of claim 9, wherein the CPU is configured to:
verify integrity of the application; and
delete a reprogram image stored in the first flash memory, when the integrity is not verified.

17. The MCU of claim 9, wherein the CPU is configured to:
load a bootloader in the RAM to execute the bootloader; and
perform an operation of writing and deleting the reprogram image in and from the first flash memory according to the bootloader.

18. The MCU of claim 9, wherein functions designated by the function pointers comprise a function handling a Non-volatile Memory (NvM) module, a function handling a Flash EEPROM Emulation (Fee) module, and a function handling a Flash Driver (Fls) module.

19. The MCU of claim 9, wherein:
the CPU is configured to, when the current version value include in the application is identified to be an upgraded value compared to the previous version value,
record the previous version value, recoded in a first block of the second flash memory, in a second block of the second flash memory, and
record the current version value in the first block of the second flash memory.

20. A non-transitory computer-readable medium storing computer-readable instructions that, when executed by a processor, cause the processor to:
write a reprogram image in a first flash memory;
identify a previous version value of an application stored in a second flash memory by calling, through a bootloader, a function designated by one of function pointers, which are recorded in a predetermined location in the application to be loaded by the reprogram image; and
delete the reprogram image written in the first flash memory, when a current version value included in the application is identified to be a downloaded value compared to the previous version value.
